(19) United States
(12) Patent Application Publication
(10) Pub. No.: US 2021/0048656 A1
(43) Pub. Date: Feb. 18, 2021

(54) VIRTUAL STOP OPTICAL SYSTEMS, METHODS, AND STRUCTURES

(71) Applicant: GOJOYA INC., Saratoga, CA (US)

(72) Inventor: Gordon C. WILSON, SAN FRANCISCO, CA (US)

(73) Assignee: GOJOYA, INC., SARATOGA, CA (US)

(21) Appl. No.: 16/792,202

(22) Filed: Feb. 15, 2020

Related U.S. Application Data
(60) Provisional application No. 62/885,542, filed on Aug. 12, 2019.

(51) Int. Cl. G02B 17/08

(52) U.S. Cl. CPC G02B 17/0856

(57) ABSTRACT

Aspects of the present disclosure describe virtual stop optical systems, methods and structures employing either positive- or negative-curvature virtual stop.

### CROSS REFERENCE

This disclosure claims the benefit of U.S. Provisional Patent Application Ser. No. 62/885,542 filed Aug. 12, 2019, the entire contents of which are incorporated by reference as if set forth at length herein.

### TECHNICAL FIELD

This disclosure relates generally to optical systems. More particularly it pertains to virtual stop optical systems, methods, and structures employing a negative or positive curvature virtual stop.

### BACKGROUND

As is known, optical systems have found widespread applicability in contemporary society. Accordingly, advances in optical systems, methods, and structures are always welcome in the art.

### SUMMARY

An advance in the art is made according to aspects of the present disclosure directed to virtual stop optical system(s), methods, and structures employing a negative or positive curvature virtual stop.

According to aspects of the present disclosure, disclosed is an optical apparatus comprising a lens assembly including a first medium, and a second medium, the first medium exhibiting a first index of refraction, the second medium exhibiting a second index of refraction; wherein the first index of refraction is greater than the second index of refraction; wherein total internal reflection of light at an interface between the first medium and the second medium forms an aperture stop on light transmission with edges independent of field angle.

In sharp contrast to the prior art, systems, methods and structures according to aspects of the present disclosure are characterized in that the interface between the first medium and the second medium exhibits a shape configured to produce the total internal reflection such that at least a portion of the light that undergoes the total internal reflection is reflected more than once at that interface.

Consequently, systems, methods and structures according to aspects of the present disclosure advantageously permit straightforward manufacture, while substantially eliminating stray or otherwise unwanted light from reaching an imaging surface.

### BRIEF DESCRIPTION OF THE DRAWING

A more complete understanding of the present disclosure may be realized by reference to the accompanying drawing in which:

FIG. 1(A) and FIG. 1(B) are schematic block diagrams showing an illustrative prior-art lens arrangement having a virtual stop;

FIG. 2 is a schematic diagram showing an illustrative lens arrangement having a virtual stop according to aspects of the present disclosure;

FIG. 3 is a schematic diagram showing the illustrative lens arrangement of FIG. 2 having a virtual stop illustrating a path taken by a ray reflected by the second surface of L3 four times before it passes out through the first surface according to aspects of the present disclosure;

FIG. 4 is a schematic diagram showing the illustrative lens arrangement of FIG. 2 having a virtual stop with rays at a field angle of 35 degrees according to aspects of the present disclosure. Due to the monocentric symmetry, the virtual stop is identical to that at zero degrees field angle and has width D.

FIG. 5 is a schematic diagram showing the illustrative lens arrangement of FIG. 2 having a virtual stop with a field angle of 45 degrees according to aspects of the present disclosure;

FIG. 6(A), FIG. 6(B), FIG. 6(C), and FIG. 6(D) respectively show one of four configurations of two outer meniscus lenses L1 and L3 in contact with an inner ball lens L2 according to aspects of the present disclosure;

FIG. 7 is a schematic diagram showing a cross sectional view of an illustrative lens arrangement according to aspects of the present disclosure;

FIG. 8 is a schematic diagram showing a cross sectional view of another illustrative lens arrangement according to aspects of the present disclosure;

FIG. 9(A), FIG. 9(B), and FIG. 9(C) show a series of masks in which FIG. 9(A) shows a mask with a thin inner annulus and spokes; FIG. 9(B) shows a mask that includes a slit in M1 and rotationally aligned to one of the sides of the image sensor; and FIG. 9(C) shows a mask which hugs the ball lens along two opposing arcs; all according to aspects of the present disclosure;

FIG. 10(A) and FIG. 10(B) show an illustrative concentric optical alignment between a spherical ball lens and a meniscus lens according to aspects of the present disclosure;

FIG. 11(A) and FIG. 11(B) show illustrative lens designs including toroidal surfaces according to aspects of the present disclosure;

FIG. 12(A) and FIG. 12(B) show alternative illustrative lens designs including an additional meniscus lens and an air gap between the field-flattening lens and the image surface, according to aspects of the present disclosure;

FIG. 13 shown an alternative lens design similar to that in FIG. 7, except that the masks M1, M2, and M2 are replaced with a single mask M1, which is compliant such a longitudinal loading force applied to the lens stack according to aspects of the present disclosure; and

FIG. 14(A) and FIG. 14(B) illustrate alternative lens mounting arrangements according to yet other aspects of the present disclosure.

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

Finally, it is noted that the use herein of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

We begin our discussion by noting that a virtual aperture stop in an imaging lens exhibiting light rejection outside the aperture by total internal reflection (TIR) at a positive-curvature surface is disclosed in United States Patent Application Publication No. 2017/0176730 of Ford et. al., entitled TOTAL INTERNAL REFLECTION APERTURE STOP IMAGING that was filed on 16 Dec. 2016, received application Ser. No. 15/382,551, and issued on Jan. 22, 2019 as U.S. Pat. No. 10,185,134 (the '134 patent).

As will be appreciated by those skilled in the art, total internal reflection may occur at a surface interface between a first medium having a first index of refraction and a second medium having a second index of refraction wherein the first index of refraction is greater than the second index of refraction. In the '134 patent, the optical surface that provided an aperture stop by total internal reflection (the aperture-stop surface) was spherically curved with a positive radius of curvature, so that the center-of-curvature of the aperture-stop surface lies between the aperture-stop surface and the image. The surface of the low-index medium is convex while that of the high-index medium is concave.

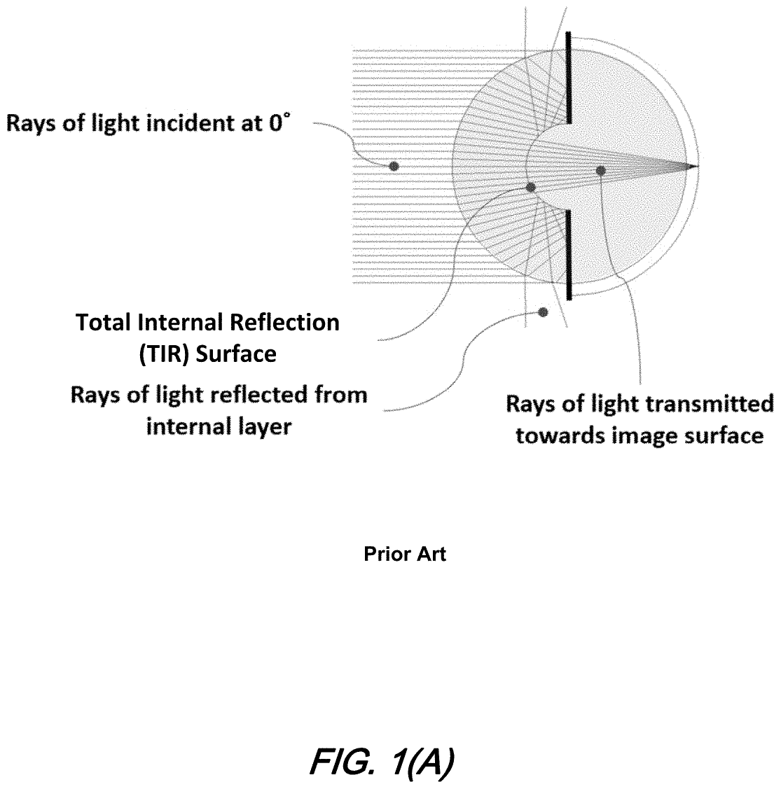

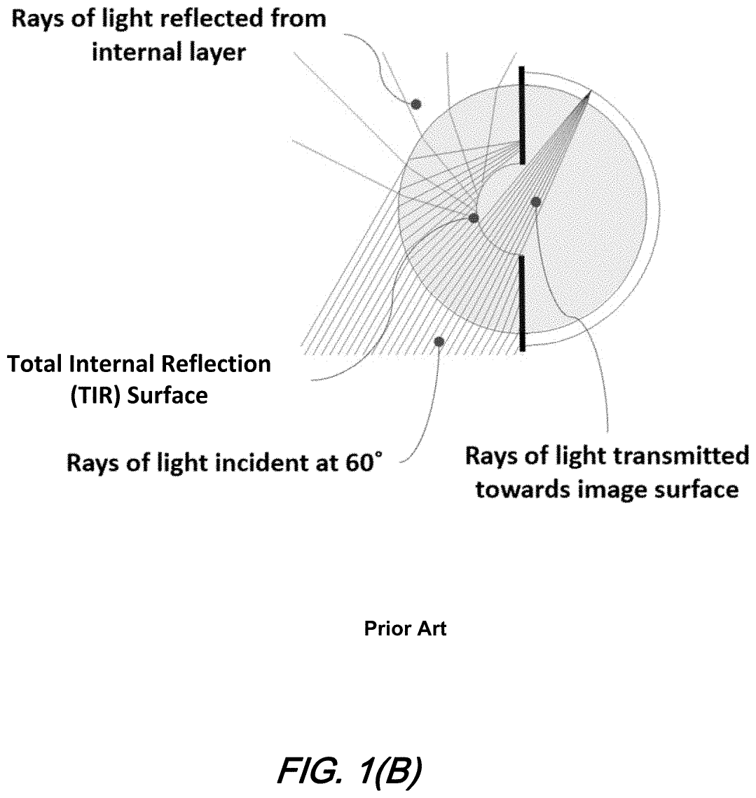

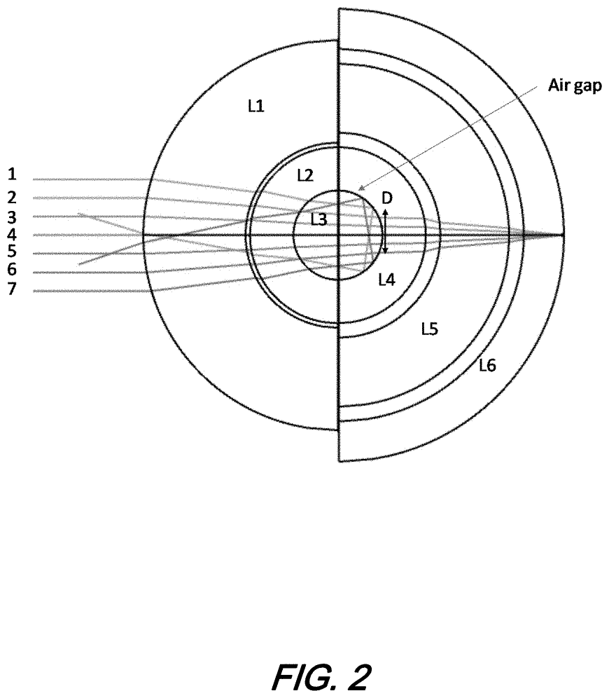

With simultaneous reference to that '134 patent and FIG. 1(A) and FIG. 1(B), it may be observed that light originating from a point in an imaged scene incident upon said interface can only be transmitted through a region within an aperture when the incident angle on that region is less than the critical angle necessary for a total internal reflection. The overall region of the lens that may transmit light thus forms an apparent (or “virtual”) aperture stop, whose effective position depends on the light source location. Rays of light falling outside of the aperture and incident upon the surface between the first and second media are reflected completely and preferably escape the system through the lens system's front field aperture or are absorbed within the system at a baffle or masked surface. The virtual aperture appears to turn to face light incident from each point in the image field.

In contrast, and according to aspects of the present disclosure, a virtual stop can also be formed at a surface forming the interface between a relatively high refractive index medium and a lower refractive index medium wherein the aperture-stop surface is spherically curved with a negative radius of curvature so that its center-of-curvature is in front of it (further from the image). Although light outside the aperture stop which undergoes TIR is not directly reflected out of the system—much of it is reflected towards the image—a properly designed virtual stop according to the present disclosure, positioned at a negative-curvature interface, advantageously and surprisingly prevents rejected light from reaching the image, resulting in an imaging system having low levels of stray light (often referred to as veiling glare or flare). For a suitably shaped interface, e.g. a sphere, a substantial fraction of any light rejected by the stop reflects from the TIR surface multiple times and eventually exits the system through the front or is absorbed internally.

According to an aspect of the present disclosure, we disclose an apparatus comprising: a lens comprising a first medium having a first index of refraction and a second medium having a second index of refraction, wherein the first index of refraction is greater than the second index of refraction; wherein an interface between the first medium and the second medium has negative curvature, and wherein total internal reflection at the interface forms an aperture on light transmission with edges dependent on the angle of light incidence. Rays of light reflected at the interface may strike the interface again at another location. If the interface has a spherical shape, then the angle of incidence of the second impingement is equal to the angle of the first, so that a ray exceeding the critical angle for the first impingement will also exceed the critical angle for the second impingement. Light rejected by the TIR aperture may thus be repeatedly reflected inside the first medium until it traverses a surface region having a higher curvature before again striking the surface, such that the angle of incidence is now less than the critical angle, or it strikes an interface with a third medium of refractive index higher than the second.

In this disclosure, wherever we refer to the light, or all the light, beyond the critical angle being reflected by total internal reflection, we recognize that in real physical systems, some small fraction of the light may not be reflected.

First, an interface is generally not perfectly smooth and may have surface contamination/imperfection such that the conditions of TIR are not completely achieved over an indicated surface region. Such a surface may be described as partially scattering or diffuse. Second, the second medium may be thin with another higher-index medium beyond it, opposite the first medium. As such, evanescent electric and magnetic fields in the second medium reach this additional medium and a fraction of the incident light is coupled into a propagating wave in this medium rather than being reflected within the first medium. Such a phenomenon of this second example is known in the art and called “frustrated total internal reflection (frustrated TIR).” Consequently, to form an effective aperture stop, the thickness of the second medium should be at least approximately/substantially one wavelength—ideally several wavelengths or more—so that the fraction of frustrated TIR relative to TIR energy is small.

In an illustrative embodiment, a first medium having refractive index n1 is substantially spherical in shape and forms one element of an imaging lens. This first medium contacts a second medium having index n2 positioned between the first medium and an image surface and contacts a third medium having index n3 positioned between the first medium and an imaged scene (the “field”). The indexes are configured such that n1>n2 and n3>n2.

Light from the imaged scene—the field—enters the imaging system, which, for example, may be a camera. Depending upon the specific configuration, such light may pass through one or more lens elements before reaching the third medium. Some fraction of this light passes into the first medium and then is incident upon the interface with the second medium. Rays of light below the critical angle at least partially pass into the second medium while some light is reflected by—for example—Fresnel reflection. For rays exceeding the critical angle, the light undergoes TIR (i.e., is TIR-ed—totally internally reflected) at that surface. The TIR-ed light may reflect multiple times within the first medium before striking the interface with the third medium, whereupon at least a fraction of the light passes back into the third medium, along a direction away from the image.

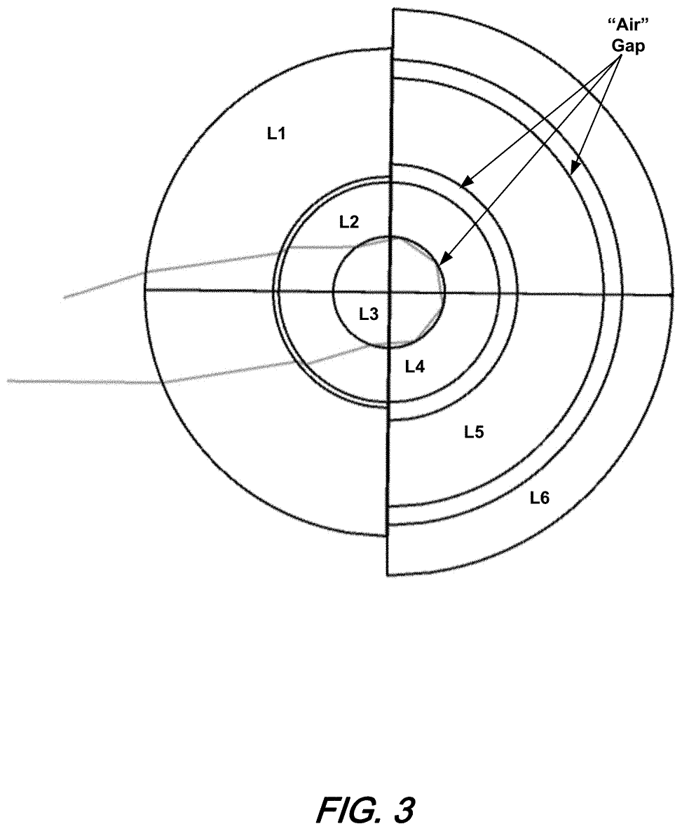

FIG. 2 shows an example of an illustrative lens structure according to aspects of the present disclosure. With reference to that figure it may be observed that light from the field enters the lens structure and passes through lens elements L1, L2, L3, L4, L5, and L6 before reaching the image, which is formed on internal spherical back surface of L6. From this figure, those skilled in the art will readily recognize that the lens structure is monocentric with lens elements positioned concentrically about a point at the center of L3. Once formed, a curved image may be relayed to one or more planar image sensors using—for example—coherent fiber bundles or relay lenses. We note that while monocentric cameras having TIR stops on positive-curvature surfaces are described further in United States Patent Application Publication No. 2017/0176730, TIR stops on both positive-curvature and negative-curvature surfaces according to aspects of the present disclosure are advantageously applicable to lenses which are not monocentric as well.

At this point we note that FIG. 2 does not specifically show any stray-light baffle which itself is an important aspect of the present disclosure. In this FIG. 2, such a light baffle would have an aperture approximately the radius of the central ball lens L3 positioned near the equator of L3 and extending out to the radius of the lens element L6, blocking light from entering the lens elements following L3 except through L3. As will be appreciated, such light baffle affects only light rays that do not enter the central ball and blocks light that would otherwise enter by a non-sequential path—through the flat edge of the various meniscus lenses. As will be appreciated further, such blocking of non-sequential, stray light, lens elements L1, L2, L4, L5, and L6 of FIG. 2 may be fabricated with an absorptive black coating on flat (non-optical) surface(s) outside the clear apertures of the lens elements. Further disclosure of such light baffle structure(s) is described in detail later in this disclosure.

With continued reference to that figure, we note that gaps exist between L1 and L2, L3 and L4, L4 and L5, and L5 and L6. The gap between L2 and L3 is preferably filled with suitable optical adhesive such that L2 and L3 form a compound lens, while the others are airgaps that are filled with air or other suitable gas or mixtures or evacuated. The TIR stop exists (is located and/or formed, etc.) at the interface between spherical element L3 and airgap located between L3 and L4. We note that since such gap is approximately 5 microns thick, it is too thin to show up as a substantial space between drawn lines in FIG. 2. In an illustrative configuration, L3 is glass N-LAF36 with refractive index 1.80 and L2 is S-LAH79 with refractive index 2.00.

To minimize Fresnel reflections, the adhesive between L2 and L3 should have index between that of L2 and L3, but, at a minimum, it (the index) must be large enough so that the TIR stop is not formed at the interface between L2 and the adhesive rather than at the airgap between L3 and L4. For light to undergo TIR within a sphere, it must pass into the sphere from a medium of higher index than the medium outside the sphere on portions of the surface where TIR occurs.

As may be observed from illustrative FIG. 2, there is shown seven parallel rays (1, 2, 3, . . . 7) entering the lens arrangement, each individual ray originating from a point on an object located at infinity. All the rays strike the back (second) surface of L3. Rays 2-6 are incident at angles below the critical angle such that only a portion of the light is reflected, and a portion propagates to the image surface. As will be appreciated, the fraction of light transmitted depends on the angle of incidence for each ray and on the design of an optional antireflection coating on the surface of L3. The fraction of light transmitted is large for paraxial rays and decreases for marginal rays as the incident angle approaches the critical angle so that that the aperture is apodized rather than sharply transitioning from transmitting to blocking.

FIG. 2 does not show rays corresponding to the partial reflections of rays 2-6. Rays 1 and 7 are incident at angles beyond the critical angle and undergo TIR. Both rays strike the TIR surface a second time, are TIR-ed, and then pass out the front of the lens structure. Since L3 is a sphere, the second and all subsequent intersections with the surface are at the same incident angle as the first, so if the ray is TIR-ed at the first incidence, it is again TIR-ed at all subsequent incidences until it is incident on a region of the spherical lens surface followed by a medium of sufficiently high index, such as the adhesive at the front (first surface) of L3, and a significant fraction of the light escapes the sphere. We note that the surface does not literally have to be a sphere for our general approach to work, however. One such example would be the configuration where the lens was hemispherical, and the front face was flat. More generally, the surface may be an asphere.

We note that TIR occurs, imaging at infinite conjugate, over a virtual aperture of diameter D. For lower image conjugates, the incident angles of non-paraxial rays are larger, and the aperture diameter is slightly different.

It may be observed that FIG. 2 shows the second TIR of rays 1 and 7 occurring outside of the aperture, at a radial position greater than D/2, but for more marginal rays, the second TIR could occur within the aperture stop at a radial position less than D/2. However, this light would still not pass through the aperture because it is incident at an angle beyond the critical angle. Also, rays more marginal (farther from the chief ray) might be reflected more than two times before exiting the sphere.

FIG. 3 is a schematic diagram showing the illustrative lens arrangement of FIG. 2 having a virtual stop illustrating a path taken by a ray reflected by the second surface of L3 four times before it passes out through the first surface, according to aspects of the present disclosure. Those skilled in the art will readily appreciate and understand that as the field angle for imaged light is varied, the incident angle of rays entering the first medium (L3) changes.

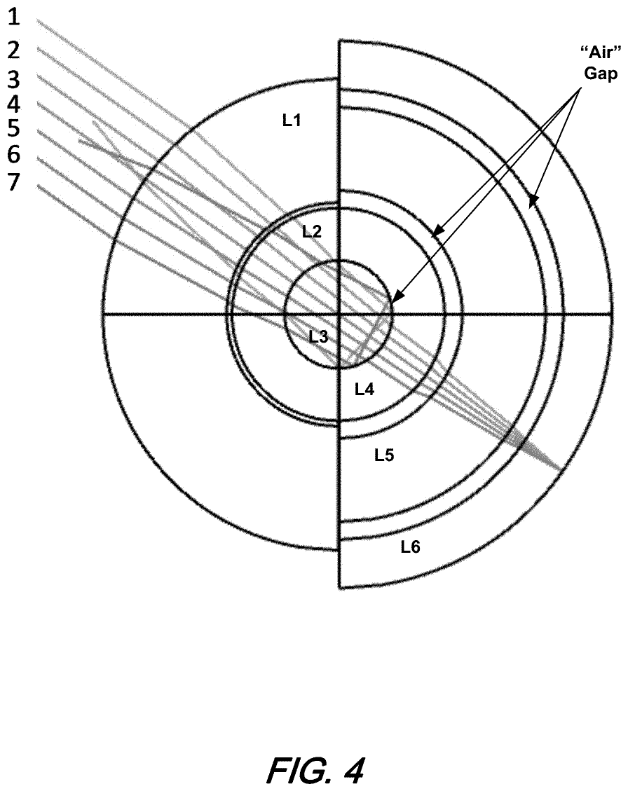

FIG. 4 is a schematic diagram showing the illustrative lens arrangement of FIG. 2 having a virtual stop with rays at a field angle of 35 degrees according to aspects of the present disclosure. Due to the monocentric symmetry, the virtual stop is identical to that at zero degrees field angle and has width D.

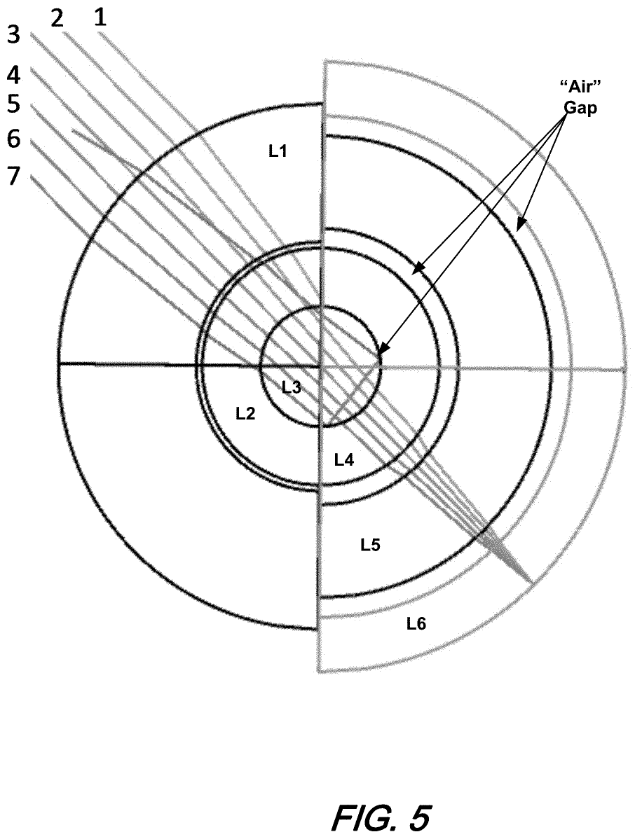

FIG. 5 is a schematic diagram showing the illustrative lens arrangement of FIG. 1 having a virtual stop with a field angle of 45° degrees according to aspects of the present disclosure. In the arrangement shown in FIG. 5, since the field angle is 45° ray 1 misses the front hemisphere (first surface) of L3 (i.e., it is vignetted). The region outside of L3 between the edges of L2 and L4 is preferably absorbing. The edge of L2 may be coated with black ink or the gap between L2 and L4 may contain a baffle or absorbing medium such as carbon-black-filled adhesive. Alternatively, a region of the sphere L3 near its equator may be coated with a black material, forming an aperture. The black coating has a refractive index greater than 1 so the critical angle is higher than it is within the aperture.

Note that the element L3 need not be perfectly spherical. It may be beveled or grooved near its equator to facilitate mounting, resulting in vignetting beginning at a smaller field angle than is the case for a complete sphere with no beveled or grooved region. Moreover, the first and second optical surfaces of L3 need not be exactly spherical within their clear apertures. If the curvature of the second surface increases in magnitude with lateral distance from the optical axis, then subsequent reflections from the second surface after initial TIR at locations closer to the optical axis than the initial incidence occur at angles larger than the initial incident angle and hence are beyond the critical angle. We note that—generally speaking—an optical axis is a line along which there is some degree of rotational symmetry in an optical system including lenses, cameras, microscopes, etc. The optical axis is an imaginary line that defines a path along which light propagates through the system—up to a first approximation. Accordingly, an optical axis is an axis of symmetry for a ball lens as used according to aspects of the present disclosure. It is also an axis of symmetry for meniscus lenses as used according to aspects of the present disclosure.

For example, this behavior occurs if the second surface is an oblate spheroid. The second surface may be an asphere having a conic constant greater than zero. It also need not exhibit rotational symmetry. Nevertheless, a monocentric design with spherical optical surfaces according to aspects of the present disclosure has the advantage that the lens performance, including the effective F#, is invariant over field angles that are not vignetted.

Advantageously—and as will be readily appreciated by those skilled in the art—spherical ball lenses may be fabricated to high precision at low cost and can be used as the central element of a lens arrangement according to aspects of the present disclosure. In an illustrative configuration, one meniscus lens may be situated on the front side and another on the back side of the ball lens with small gaps between. If the front gap is air, then the TIR stop occurs at the interface between the front meniscus lens and the air gap. If this gap is instead filled with adhesive, oil, or another material of refractive index similar to that of glass and the back gap is an air gap, then the back surface of the ball lens is the TIR stop. If both gaps are air, then the TIR stop could occur at the front or back, depending on the refractive indices of the front meniscus and the ball lens. For sufficiently high relative ball refractive index, the TIR stop is located at the negative-curvature back surface of the ball lens.

Ideally the ball lens is concentric with the concave surfaces of the front and back menisci. When the gap between the ball lens and each meniscus lens is filled with adhesive, the surface tension of the liquid adhesive prior to curing can help to center the ball lens and the viscosity of the adhesive and the force pressing the ball lens into the meniscus can determine the thickness of the adhesive layer. Also, since the index discontinuity at the adhesive-filled gap is modest, the tolerance for non-concentricity of the ball lens and the meniscus lens is forgiving. When the gap is air, the index discontinuity is large and the tolerances for relative placement of the meniscus and ball lens are tight. Large ray aberrations can result for air gap dimensions that deviate from the nominal. Moreover, aberrations increase with increasing air gap thickness.

For high volume production of small-sized (miniature) lens modules, such as those used in mobile phones, the use of optical adhesives in the optical path is generally avoided. Thus a small air gap on either side of the central ball lens is desirable, but, to maintain concentricity, the ball lens must be mounted and held about its equator, which is difficult to do if it does not have a groove or bevel or another mechanical feature about its equator, features which are difficult to produce and mount to when the ball lens is small, on the order of a few millimeters diameter or less. Moreover, to minimize vignetting, meniscus lenses on either side of the ball lens should be as close to hemispheric as possible, limiting the available volume for mounts to hold the ball lens between their edges.

One solution to this ball-lens-mounting problem is to allow contact between the ball lens and the meniscus lenses, resulting in the loss of perfect concentricity. Contact can occur either at the center of the lenses at the optical axis or at the edges of the concave surface of the meniscus lens. If the radius of curvature of the meniscus lens is slightly larger than the radius of curvature of the ball lens, and a loading force in the lens assembly presses them together, contact occurs at the lens centers on the optical axis. If the radius of the meniscus lens is less than that of the ball lens, then contact occurs at the edge of the meniscus lens where the concave meniscus surfaces transitions to the edge of the lens, which is typically flat. This transition may be a chamfered or rounded edge rather than having a sharp edge.

In a preferred embodiment, the airgap between touching lenses varies radially with zero thickness either at the center or the edges. So that TIR is not significantly frustrated, the air gap should be at least approximately one wavelength thick at the edges of the TIR stop. If the meniscus lens inner surface radius is smaller than the ball lens radius, the lenses will contact along a circle outside the aperture stop. Sufficiently close to the contact curve the gap is too small to sufficiently reject incident light by TIR. Thus, the lens design should incorporate baffles to block light from the field from reaching this contact curve vicinity or to block light passing through this region from reaching the image surface.

The lens can be assembled by placing the ball lens in one meniscus lens and then stacking the other meniscus lens on the ball lens. A modest longitudinal loading force centers the lenses relative to each other on the optical axis so as to minimize the longitudinal thickness of the lens stack during assembly. Thus, automatic substantial lens centration is achieved by registration to the optical surfaces themselves without active alignment, adhesives, or registration to a lens barrel or other mechanical mounting element. The radii of curvature must be fabricated to tight tolerances as the difference in radii between the ball lens and each meniscus sets the air gap thickness. If the thickness is too small outside the TIR stop aperture, TIR will be frustrated and light will not be sufficiently rejected. Aberrations increase with increasing air gap, limiting the lens resolution, so the gap should not be larger than about 10 microns.

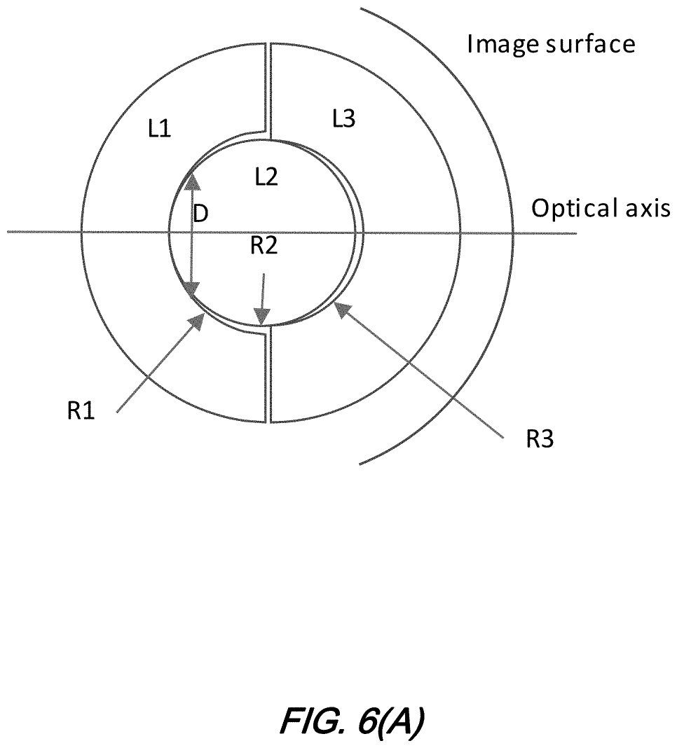

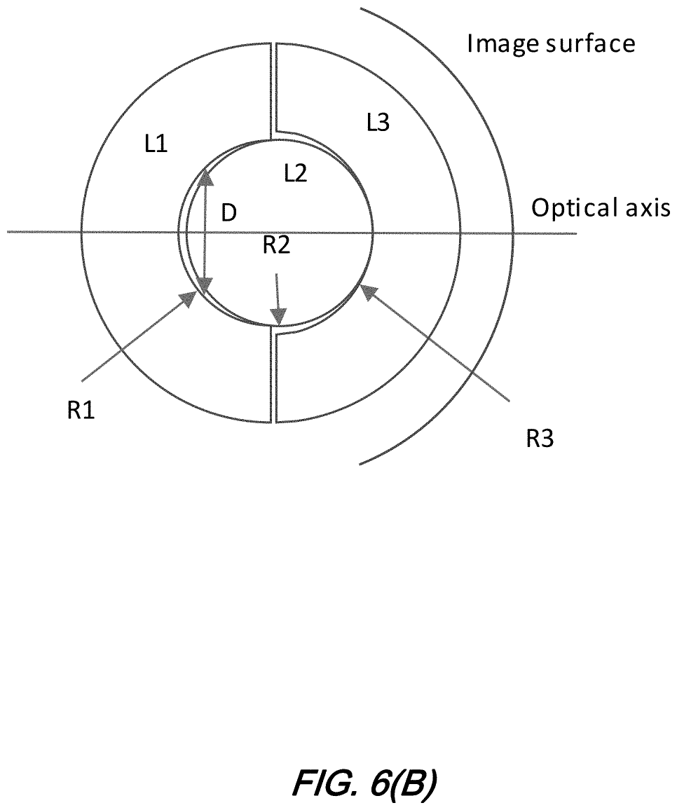

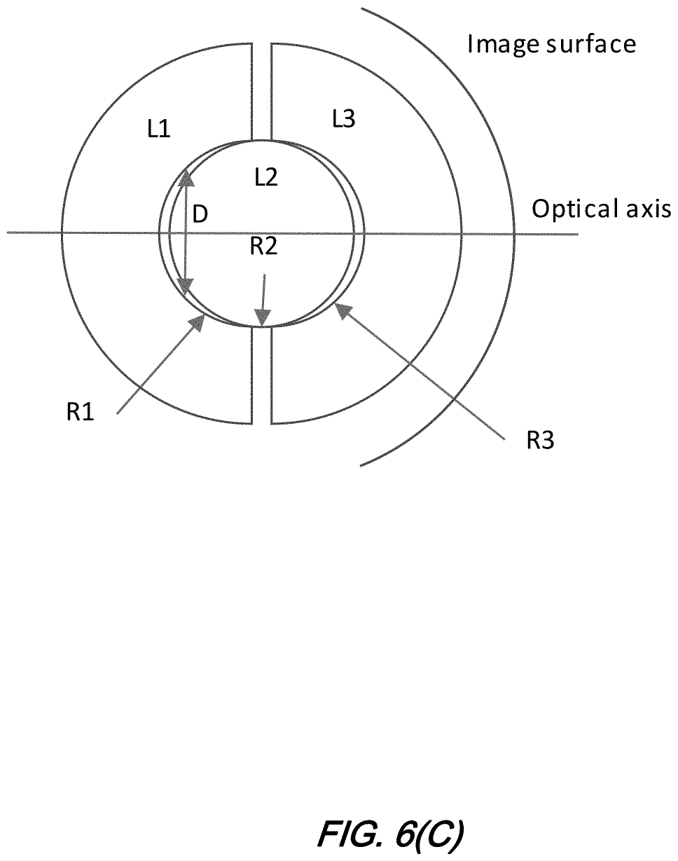

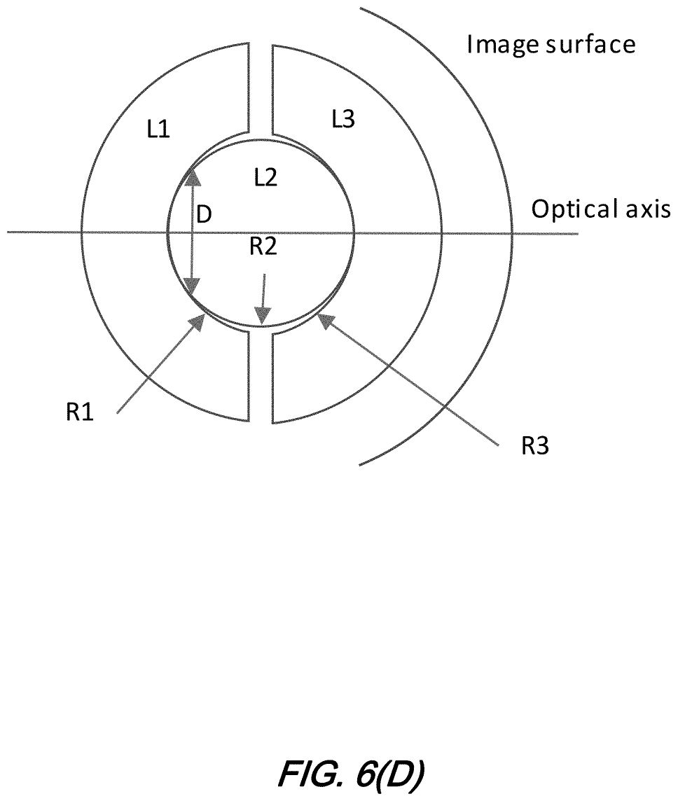

FIG. 6(A), FIG. 6(B), FIG. 6(C), and FIG. 6(D) respectively show one of four configurations of two outer meniscus lenses L1 and L3 in contact with an inner ball lens L2 according to aspects of the present disclosure. As depicted in these figures, the field is on the left side and the image is on the right. For simplicity, other lens elements may be included in the system but are not shown.

Image forming light passes from L1 to L2 to L3. TIR at the inner surface of L1 forms the aperture stop of diameter D for infinite conjugate. If the refractive index of L2 is sufficiently high relative to that of L1, the aperture stop will be formed on the back surface of L2 instead. The aperture is shown concentric with the optical axis, but it rotates with field angle, always perpendicular to the chief ray. Note that the configuration described is only illustrative and advantageously our inventive packaging techniques according to aspects of the present disclosure, TIR may be affected on either the front or rear side of the center of curvature.

In FIG. 6(A) R1>R2 and R2>R3 so the contact between L1 and L2 is on the optical axis and the contact between L2 and L3 is along a circle outside the clear aperture.

In FIG. 6(B) R1<R2 and R2<R3 so the contact area between L1 and L2 is along a circle outside the clear aperture and the contact area between L2 and L3 is on the optical axis.

In FIG. 6(C) R1<R2 and R2>R3 so the contact between L1 and L2 and between L2 and L3 are both along circles outside the clear aperture.

In FIG. 6(D) R1>R2 and R2<R3 so the contact between L1 and L2 and between L2 and L3 are both on the optical axis. In the FIG. 6(A), FIG. 6(B), FIG. 6(C), and FIG. 6(D) configurations, the differences in the radii of curvature are exaggerated for illustrative purposes.

Mounting features, not shown, hold L1 and L3 and apply a modest axial loading force along the optical axis to push them towards each other, pressing the ball lens and forcing it to be concentric with the two meniscus lenses. The outer surfaces of L1 and L3 are shown concentric with the inner surfaces, as is the case for a monocentric lens design, but they need not be, and either or both may be aspheric. The ball lenses and/or either of the meniscus lens inner surfaces need not be exactly spherical, although the ball lens is much easier to manufacture and assemble into the system if it is spherical. To maintain small air gaps, the inner surfaces of the meniscus lenses must then be close to spherical over the clear aperture.

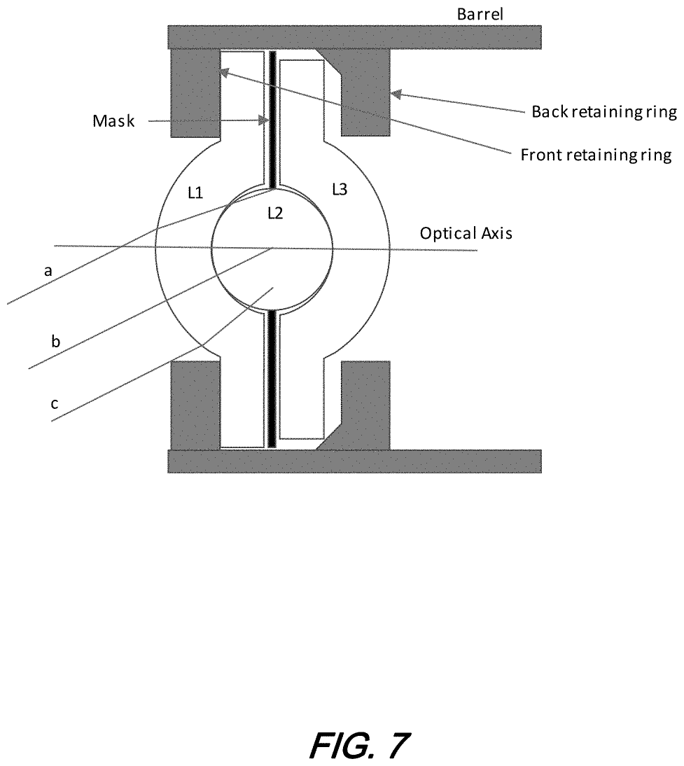

A lens assembly, or portion thereof, is illustratively shown in FIG. 7. A lens barrel contains lens elements L1, L2, and L3. L1 and L2 are molded with flange regions around their perimeters, as may, for example, be achieved by injection molding plastic. L1 and L2 hold ball lens L3 with contact along the optical axis, although the three lenses could contact any of the configurations of FIG. 6.

An annular opaque mask is situated between the flanges of L1 and L2. The inner diameter of the mask is a close match to the diameter of L2 so that little or no light reaches the image surface without passing through the ball lens. Rays eccentric to the ball lens are blocked by the mask. The mask may comprise multiple stacked individually stamped or cut sheets of black material, such as a plastic or metal. The inner diameter of subsequent sheet apertures might decrease with distance from the ball equator to maintain a small clearance between at least the outermost sheets and the ball. A similar mask shape, hugging the ball at its front and back surfaces could be produced from a single piece of material.

The total thickness of the mask is slightly less than the gap between the L1 and L3 flanges such that the axial loading force is applied to L2, not to the mask. The axial loading force is supplied by retaining rings on either side of the L1 and L2 flanges. The lens system could comprise other lens elements (not shown) with flanges and these flanges, along with additional masks, may be interposed between the retaining rings such that the axial loading force is applied to L1 and/or L2 through contact with one or more of these interposed elements, rather from direct contact with the retaining rings. Also, one of the retaining rings may be formed as a shoulder on the lens barrel, rather than as a separate part. The mask serves as a baffle that introduces vignetting for large field angles. Other baffles in the system may also introduce vignetting.

FIG. 7 is a schematic diagram showing a cross sectional view of an illustrative lens arrangement according to aspects of the present disclosure. With reference to that figure, it may be observed that a front retaining ring serves as a field aperture baffle. Three rays are shown entering the system from a point on an object located at infinity. The ray paths are not shown beyond the middle of the ball lens, but the rays continue to an image surface where they are focused to a small patch, or, absent aberrations, a point. The chief ray is identified in the figure as ‘b’. Ray ‘a’ illustrates a marginal ray defined by the mask.

In this arrangement and example shown, it is likely that the TIR stop would yield a smaller aperture at this field angle than the mask so ray ‘a’ might be reflected by TIR at the inner surface of L1 and not reach the aperture defined by the mask. However, if the gap between the flanges of L1 and L3 were sufficiently large and the mask filling it sufficiently thick, the mask would block a marginal ray closer to the chief ray and which was incident on the second surface of L2 at less than the critical angle so that the mask caused vignetting rather than TIR limiting the aperture for this marginal ray. In general, a less marginal ray is closer to the chief ray but not the optical axis.

Note that a marginal ray, ‘c’, just clears the front retaining ring, which blocks more marginal rays (not specifically shown) from entering the system. The aperture stop for sagittal rays in a plane perpendicular to the plane of incidence that includes the chief ray ‘b’ is the TIR stop on the second surface of L1. As the field angle is increased, vignetting from either the mask or the field aperture (or another aperture not shown in FIG. 7) occurs first for a lateral ray in the plane of incidence.

Note further that a small clearance exists between the edges of the flanges of either L1 and L3, or both, and the inner surface of the lens barrel so that the relative centration of L1, L2, and L3 is determined by the contact between the optical elements themselves. For example, the back retaining ring could have a beveled conical surface, as shown in FIG. 6, that contacts the edge of the L3 flange so that L3 is forced to be concentric with the retaining ring. The front retaining ring contacts the flange of L1 on its planar front surface so that it does not constrain L1's lateral position. Rather the lateral position of L1 is constrained by contact with L2 which is constrained laterally by its contact with L3 such that the back retaining ring, L1, L2, and L3 are concentric. Well-known optical mounting techniques enable variations on this arrangement to hold the subassembly L1/L2/L3 relative to the rest of the optical system. L1, L2, and L3 are held concentric by mutual contact and an axial loading force, which is an aspect of this invention. The tilt of L1 and L3 need not be tightly controlled, particularly if the front and back surfaces are concentric spheres, or nearly so.

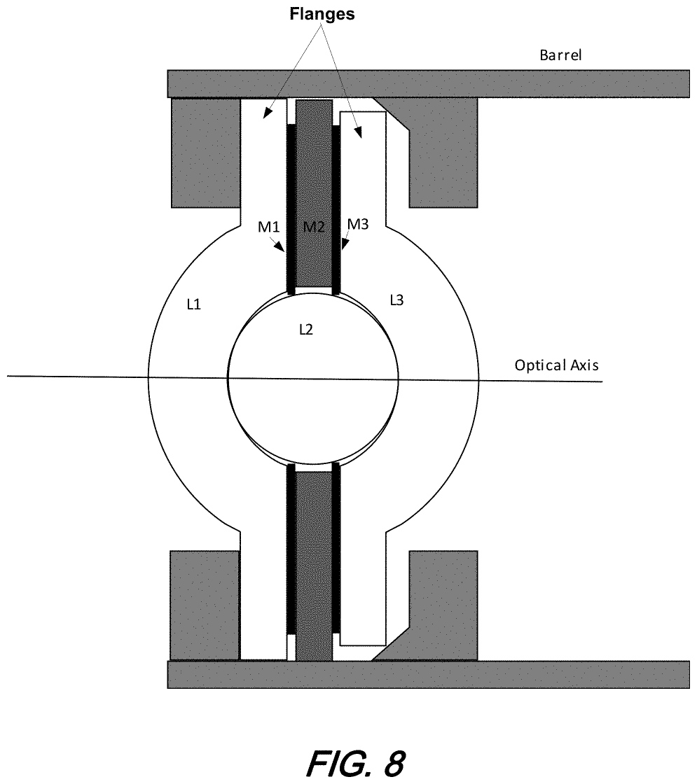

FIG. 8 is a schematic diagram showing a cross sectional view of another illustrative lens arrangement according to aspects of the present disclosure. As may be observed from that figure, the arrangement illustratively shown in FIG. 8 is somewhat similar to that shown in FIG. 7 however a gap located between flanges of L1 and L3 is larger—the flanges are spaced further apart from one another. The mask comprises three sheets M1, M2, and M3, where M1 and M3 are thinner than M2 and M2 is positioned in-between M1 and M3. In some embodiments, only two masks, M1 and M2 or M2 and M3, may be needed and/or employed. One or both of outer masks, M1 and M3, have inner diameters that closely hug the ball lens L2. M2 can have a larger ID and a larger OD so that the combined stack blocks light from an outer radius, which could be at or near the inner surface of the barrel, to an inner radius defined by the aperture in M1 or M3.

In an illustrative alternative embodiment, M1 and/or M3 contact the ball lens L2 so that apertures are formed on the surface of L2. M1, for example, may be made from an elastic material, such as rubber or plastic, that is stretched by the inserted ball lens L2. The shape of M1 need not be a complete annulus.

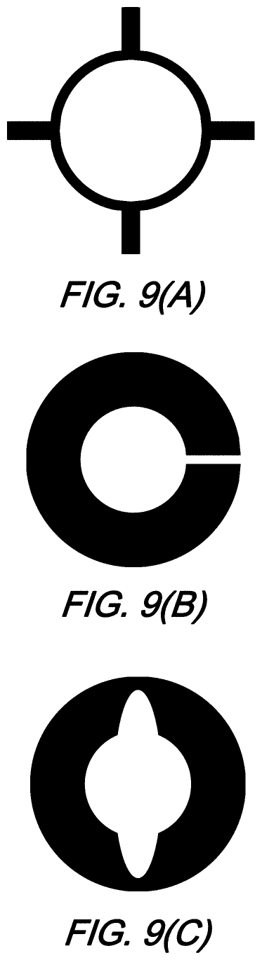

FIG. 9(A), FIG. 9(B), and FIG. 9(C) show a series of masks in which FIG. 9(A) shows a mask with a thin inner annulus and spokes; FIG. 9(B) shows a mask that includes a slit in M1 and rotationally aligned to one of the sides of the image sensor; and FIG. 9(C) shows a mask which hugs the ball lens along two opposing arcs; all according to aspects of the present disclosure.

FIG. 9(A) shows a mask with a thin inner annulus and spokes. The inner annulus is easily deformed, and the spokes help to center the mask in the barrel during assembly, although its final centration is determined by the ball lens.

We note that many imaging systems do not record the entire image circle. For example, a rectangular image sensor crops the image circle on four sides. The mask M1 may only provide vignetting in the corners of the image sensor. Thus, a complete circular aperture on the ball lens is not required. A slit may be included in M1 (FIG. 9(B)) and rotationally aligned to one of the sides of the image sensor. The slit allows M1 to flex and fit around the ball lens with less stress than a complete annular shape.

FIG. 9(C) shows a mask which hugs the ball lens along two opposing arcs. The cutout on the top and bottom of the inner radius provides greater flexibility and is rotationally aligned to portions of the image that do not require vignetting by the mask. The three shapes may be combined, or similar shapes may be used to increase mask flexibility. The mask M1 is typically combined with another mask M2 and/or other baffles which together block the majority of light paths between the ball lens L2 and the barrel, thereby minimizing stray light on the image sensor. Stacked masks of various IDs, and preferably some flexibility, allow for an aperture to be formed on the center ball lens L2 utilizing standard high-production-volume assembly processes without the use of adhesives, inks, or paints applied to the optical elements.

Contact between a ball lens and one or more meniscus lenses on spherical surfaces of different radii results in a nonconcentric structure whose optical properties vary with field angle. When the difference in radii is small, on the order of several microns, the variation is small. However, it is desirable to achieve a concentric alignment with contact between monolithic ball and meniscus lens elements with an air gap between them.

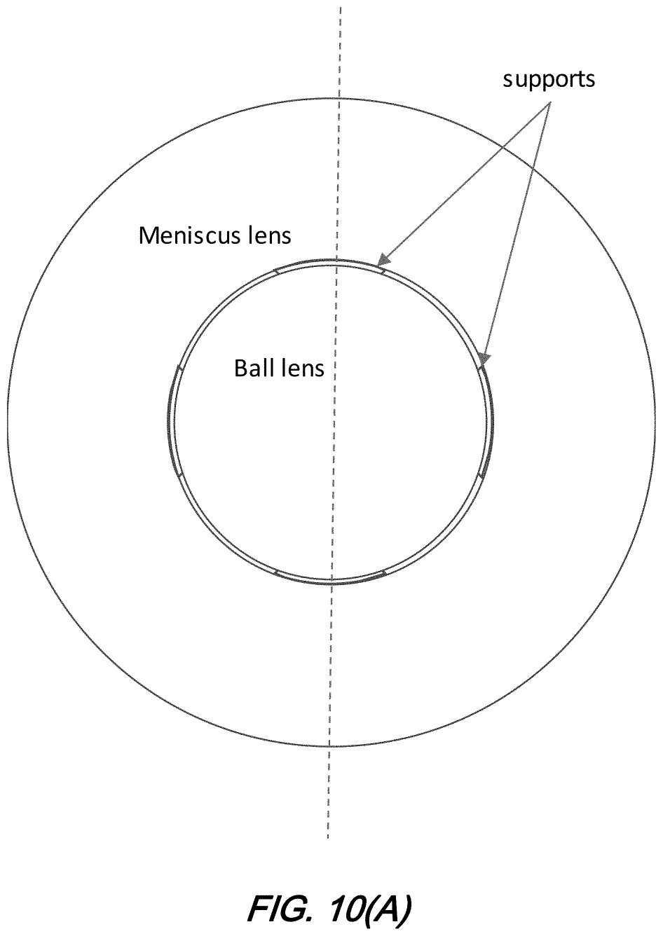

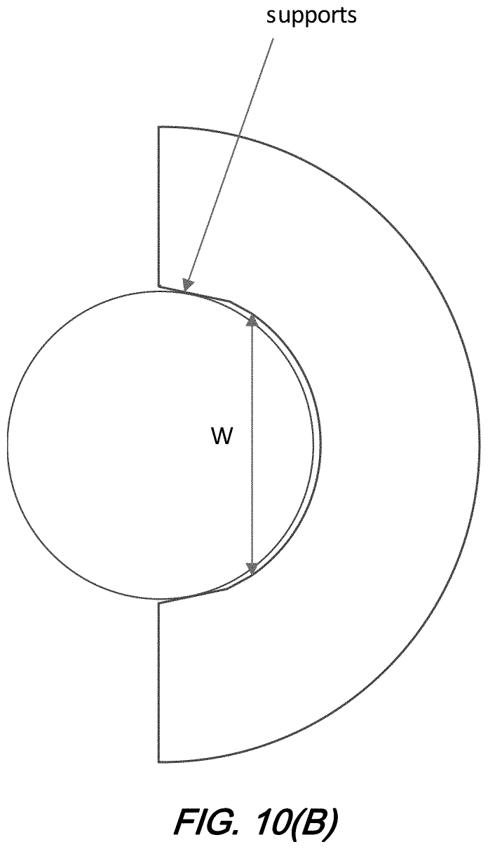

FIG. 10(A) and FIG. 10(B) illustrate a concentric optical alignment between a spherical ball lens and a meniscus lens, where FIG. 10(B) is cross-sectional view of FIG. 10(A), in the plane indicated by the dotted line in FIG. 10(A). As illustrated in the figures, the concave surface of the meniscus is concentric with the ball lens. In this example, the convex surface is also concentric with the other two, although it need not be. The meniscus lens has one or more supports the protrude from the concave spherical surface of the meniscus lens beyond the clear aperture. The ball lens rests upon these supports. The supports are shaped and positioned on the meniscus such that a mating ball lens of appropriate radius is concentric, or nearly so, with the concave meniscus surface. The meniscus may be a molded monolithic element so that each instance of the element is nearly identical, allowing for the mass production of lens assemblies with consistent alignment between mating lens elements.

A single support in the shape of a cone may support the ball lens along a circle. The conical support may be broken into sections. Other shapes besides cones are also possible including planar wedge-like surfaces.

FIG. 10(A) shows 4 conical supports. As will be readily appreciated by those skilled in the art, these supports limit the clear aperture in two directions separated by 90 degrees to a width W. However, at azimuths beyond the supports (e.g. in directions 45 degrees from the supports) the clear aperture can be larger so that a rectangular image may be created by a lens system that includes the structure of FIG. 10(A), with a TIR stop on the concave meniscus or convex ball lens surface such that the sides of the rectangular image are aligned approximately to the 4 supports and the image diagonals lie in planes that include the optical axis and which pass between the supports. This design principle can be achieved with two supports—FIG. 10(B)—or a larger number of supports. Also, the meniscus lens and the ball lens do not need to maintain spherical shapes outside the clear aperture.

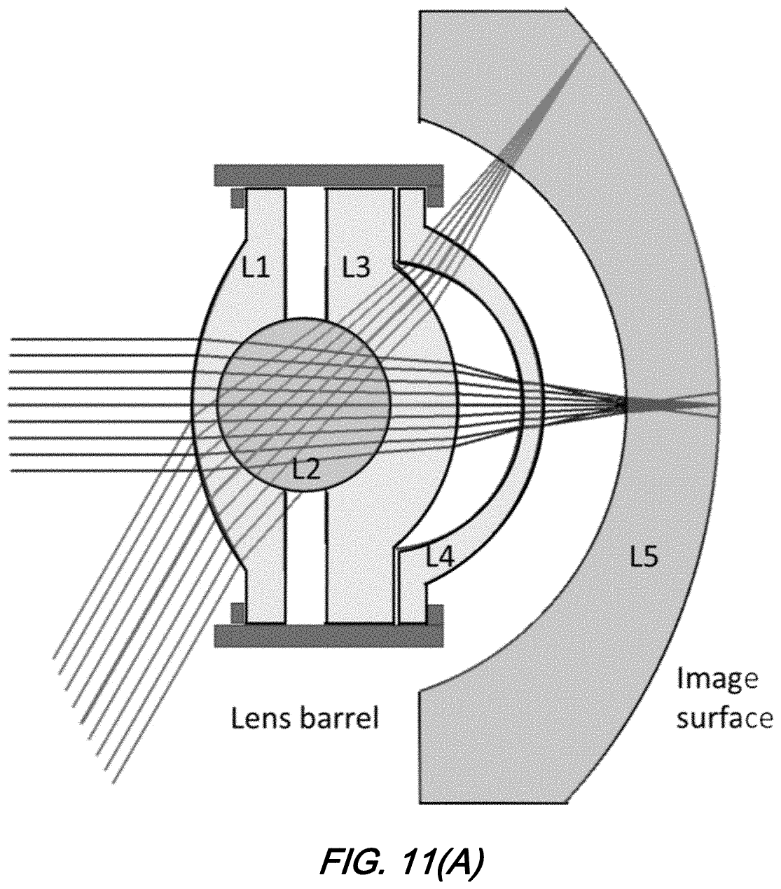

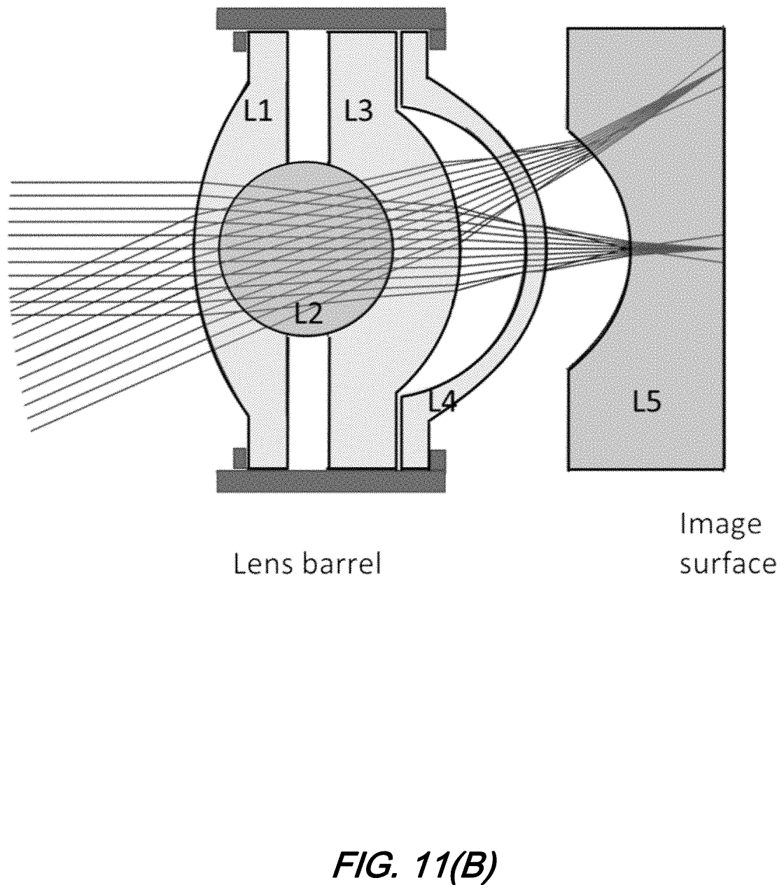

FIG. 11(A) and FIG. 11(B) illustrate a lens design somewhat like that disclosed in 2017/0176730—that now includes toroidal surfaces. Table 1 and Table 2 show an illustrative prescription for a lens such as that illustrated in FIG. 11(A) and FIG. 11(B).

TABLE 1

| | | | Thick- | | Abbe | Clear |
|---|---|---|---|---|---|---|
| Element | Type | Radius | ness | index | Number | Diameter |
| L1 | EVANASPH | 2.635 | 0.274 | 1.535 | 56.07 | 3.600 |
| | STANDARD | 0.933 | 0.000 | | | 1.830 |
| L2 | STANDARD | 0.930 | 1.860 | 1.532 | 50.90 | 1.860 |
| | STANDARD | −0.930 | 0.000 | | | 1.860 |
| L3 | STANDARD | −0.933 | 0.743 | 1.616 | 25.79 | 1.690 |
| | EVANASPH | −2.118 | 0.688 | | | 3.008 |
| L4 | EVANASPH | −1.731 | 0.221 | 1.633 | 23.26 | 3.099 |
| | TOROIDAL | −1.899 | 0.914 | | | 3.829 |
| L5 | TOROIDAL | −1.428 | 1.000 | 1.810 | 40.95 | 5.392 |
| IMA | TOROIDAL | Infinity | 0.000 | | | 8.652 |

TABLE 2

| | | Radius Of | r\hat{ }4 | r\hat{ }6 | r\hat{ }8 | r\hat{ }10 | r\hat{ }12 | Norm |
|---|---|---|---|---|---|---|---|---|
| Element | Conic | Rotation | term | term | term | term | term | Radius |
| L1 | −0.616 | | −5.66E−03 | 1.09E−03 | −3.83E−04 | | | 1 |
| | 0.000 | | | | | | | |
| L2 | 0.000 | | | | | | | |
| | 0.000 | | | | | | | |
| L3 | 0.000 | | | | | | | |
| | −1.229 | | −1.15E−02 | −8.93E−03 | 2.16E−03 | −1.19E−03 | 2.69E−04 | 1 |
| L4 | 0.222 | | 3.84E−03 | −8.33E−03 | 5.50E−03 | −1.88E−03 | | 1 |
| | −1.024 | −2.113 | −2.57E−02 | −1.22E−02 | 4.54E−03 | | | 2 |
| L5 | −0.094 | −3.268 | | | | −3.73E−03 | 2.91E−03 | 4.4 |
| IMA | 0.000 | | | | | | | |

According to the illustrative prescription, the image surface is cylindrical, or otherwise curved in one direction. A thin semiconductor image sensor, such as a CMOS or CCD image sensor, may be flexed along one axis so that its cross section in one dimension forms a curve, which may be an arc of a circle or an ellipse or other noncircular curve, while the cross section in the orthogonal direction is substantially a line segment.

FIG. 11(A) illustrates one cross section (x-z plane) in which the image surface is circular in shape and FIG. 11(B) illustrates the orthogonal cross section (y-z plane) in which the image surface appears as a line segment. The system includes a ball lens L2 held between two meniscus lenses L1 and L3. The radius of the ball lens may be slightly different than the radii of each of the two concave surfaces of menisci L1 and L3, with radius-of-curvature ratios for the three surfaces corresponding to one of those illustrated in FIG. 6(A), 6(B), 6(C), or 6(D).

Alternatively, either L1 or L3 or both may have supports on its inner surface to contact L2, as shown illustratively in FIG. 10(A) and FIG. 10(B). The first surface of L1 has a radius larger than if it were a sphere concentric with the second surface of L1, thereby expanding the FOV over which vignetting at the edges of the clear apertures of L1 and L3 does not occur, compared to a design with the first surface of L1 concentric with the second surface, such as a fully or nearly monocentric design.

L1 and L3 both contact L2 at the center axis points on the front and rear face of lens L2, but air gaps exist between L1 and L2 and between L2 and L3 through which the marginal rays pass, such that at a TIR stop is formed either at the first or second air gap. For the detailed design of Table 1, the TIR stop is at the second surface of L1.

L4 is a meniscus lens with a spherical or aspherical first surface and a toroidal second surface, that has negative optical power in both axes. L5 is a toroidal lens whose first surface is concave. The second surface of the L5 is close to or coincident with the image surface. The toroidal axes of rotation of L4, L5, and the image surface are all substantially parallel. Together, L5 and L4 function as a field flattener that flattens the field in the y direction so that an image is focused onto the cylindrical image surface. L5 may be molded glass of high refractive index, preferably 1.7 or greater, to flatten the field with minimal residual aberrations. A curled semiconductor sensor may be located proximate to, or adhesively bonded to, the second surface of lens L5.

The lens design illustrated in FIG. 11(A) and FIG. 11(B) may advantageously be extremely compact. For example, the total optical track may be 4.6 mm, 5.0 mm, 5.7 mm, or 6.4 mm or values there between. L1, L3, and L4 may be injection molded plastic lenses with flanges, as shown in simplified form in FIGS. 11(A) and 11(B). L2 is preferably a glass ball lens. These 4 lens elements may be assembled in a lens barrel in a manner that is conventional except for the fact that a ball lens is supported between two meniscus lenses. Note that FIGS. 11(A) and 11(B) do not fully illustrate the lens mounting features including masks, baffles, retaining rings, and features on the lens flanges to align the lens elements to each other and to the lens barrel. The mechanical features and masks (baffles) shown in FIG. 7, FIG. 8, or FIG. 9 or other well-known optomechanical structures may be employed to mount the lens elements and block stray light.

In a compact design, the space between the edges of L1 and L3 may not be large enough to easily situate a lens mount capable of securely holding the ball lens L2. L2 may be adhesively bonded to L1 or L3 or both, but a stack without adhesive in the optical path is faster to assemble. The system is focused by moving the front assembly of L1, L2, L3 and L4 relative to a back assembly comprising L5 and the image sensor. This front assembly must be precisely aligned in to back assembly adjusting the x, y, z, and θ_{z} relative orientation during production of the complete assembly. The θₓ and θ_{y} tilts also must be aligned to the back assembly, but with less precision.

Visible-light cameras utilizing silicon sensors typically include an IR-cut filter to attenuate near IR (NIR) light that passes through any color filters on the individual pixels (e.g. an RGB Bayer pattern) and contributes to the pixel signals. For example, the filter might strongly attenuate wavelengths between 700 nm and 1100 nm. IR cut filters are often interference filters on planar glass substrates. Multilayer dielectric filters with sharp filter edges are difficult to produce on curved substrates. Alternatively, an IR-cut filter may be fabricated as a flat piece of color glass—meaning glass containing at least one IR absorbing dye or other substance with a nonuniform absorption spectrum such as a pigment, a colloidal suspension (e.g. metal particles with plasmonic absorption resonances), quantum dots, rare-earth or other optically absorbent ionic glass dopants, or color centers. The color spectrum of light transmitted through both multilayer dielectric filters and color glass filters typically depends on illumination angle, especially for a wide range of angles. Typically, IR filters are placed between the lens and the image sensor, but the toroidal lens camera of FIG. 10 cannot physically accommodate a planar filter that covers the field of view except in front of the lens. Due to the wide field of view, the filter here must be large and cover a large range of incident angles, which degrades the sharpness of a planar interference filter.

To minimize the filter cost and the size of the camera, the central ball lens L2 may be made of an IR absorbing glass, obviating the need for an added filter element. L2 may also, or instead, filter other wavelength bands such as UV light. Dyes (or other light absorbent substances) in the glass melt are selected to achieve the desired absorption spectrum. Since the aperture stop is at L2, it has a small volume and the cost of the IR filter is minimized. Also, glass ball lenses are cheaper to fabricate precisely than standard glass lenses with a front and back surface that are in general not concentric or having the same radius of curvature. The spherical symmetry of the ball lens advantageously provides a total optical path length that is substantially independent of field angle, and so the color spectrum of the transmitted light is also substantially independent of the field angle.

To correct aberrations, the surfaces of the meniscus lens L4 have larger curvature than the second surface of L3. The gap between L3 and L4 at the edge of the clear aperture is optimally as small as possible, less than 0.30 mm or less than 0.20 mm, while the gap along the optical axis is greater than 0.50 mm and is optimally greater than 0.60 mm.

The lens design illustrated in FIG. 11(A) and FIG. 11(B) each has a FOV of 120° in the x direction and 48° in the y direction, parallel to the axis of the cylindrical image surface. FIG. 11(B) shows rays for 0° and 24° field angles. TIR at the second surface of L1 defines the aperture stop for both field angles. FIG. 11(A) shows rays for 0° and 60° field angles.

On axis, the TIR stop at the second surface of L1 fully defines the aperture stop. At 60° TIR defines the stop in the sagittal plane while vignetting by the edges of L1 and L3 define the stop in the tangential plane. The marginal rays shown in FIG. 11(A) and FIG. 11(B) are clearly highly aberrated, but they are also highly attenuated by Fresnel losses at the air gaps between L1 and L2 and L2 and L3 (the aperture is apodized by Fresnel losses) so that they have minimal impact on the system resolution. The lens design of FIG. 11(A) and FIG. 11(B) have an effective focal length of 3.86 mm and F# of 2.4. The size of the image sensor, uncurled, is 3.9×8.54 mm.

Notably, the width of the image sensor is 2.2 times the effective focal length, indicating a combination of large FOV and high angular resolution. The relative illumination is >0.5 at the 60° field angle, which is notable for a wide-angle lens with a total track of 5.7 mm, only 1.48 times the effective focal length.

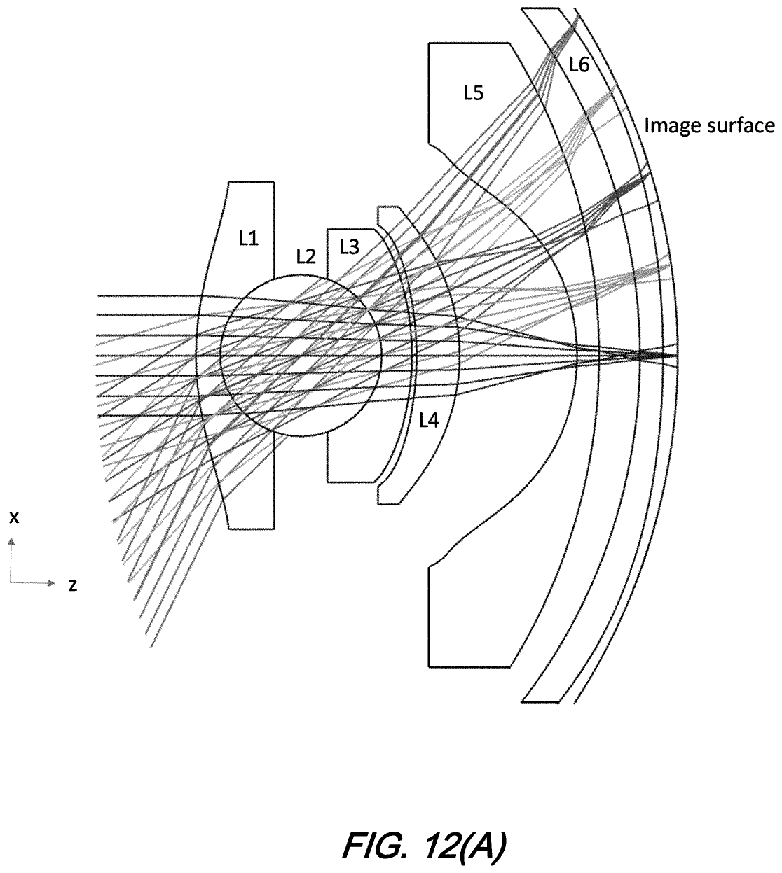

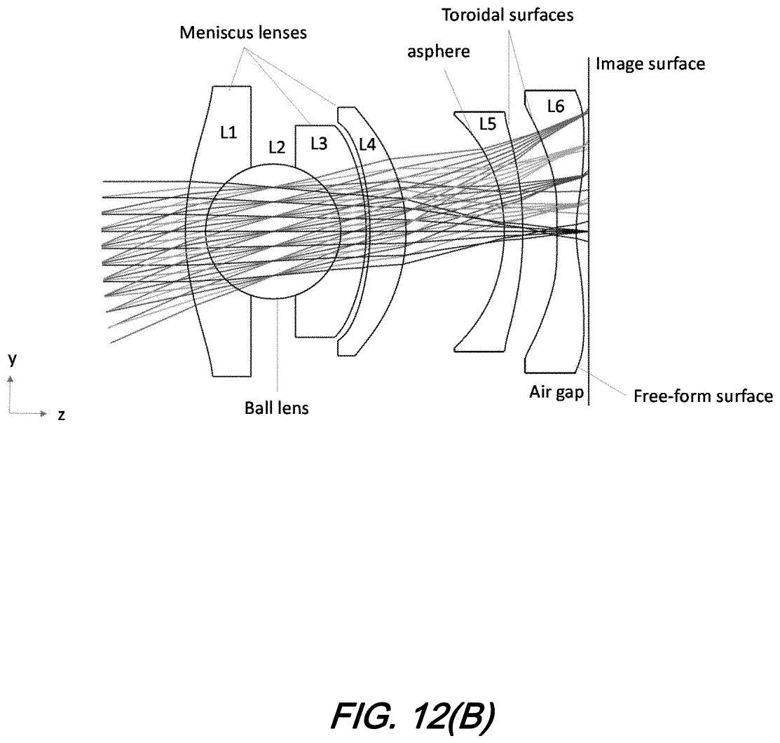

FIG. 12(A) and FIG. 12(B) show an alternative illustrative lens design including an additional meniscus lens element L4 following the second meniscus lens L3, according to aspects of the present disclosure. The field-flattening lens L6 in front of the image surface may advantageously be constructed from a molded plastic rather than glass. Between the second surface of this lens and the image sensor is an air gap. And while the second surface of L6 is not cylindrical in shape, it may be toroidal or free-form (lacking circular symmetry about any axis), as shown.

The intersection of the second surface of L6 with the y-z plane exhibits positive curvature near the optical axis and negative curvature for the largest y-field angle, thereby reducing angles of refraction from L6 and the incident angles on the image surface for extreme y image heights. The intersection of the first surface of L5 with the x-z plane exhibits negative curvature near the optical axis and positive curvature for the largest x-field angle.

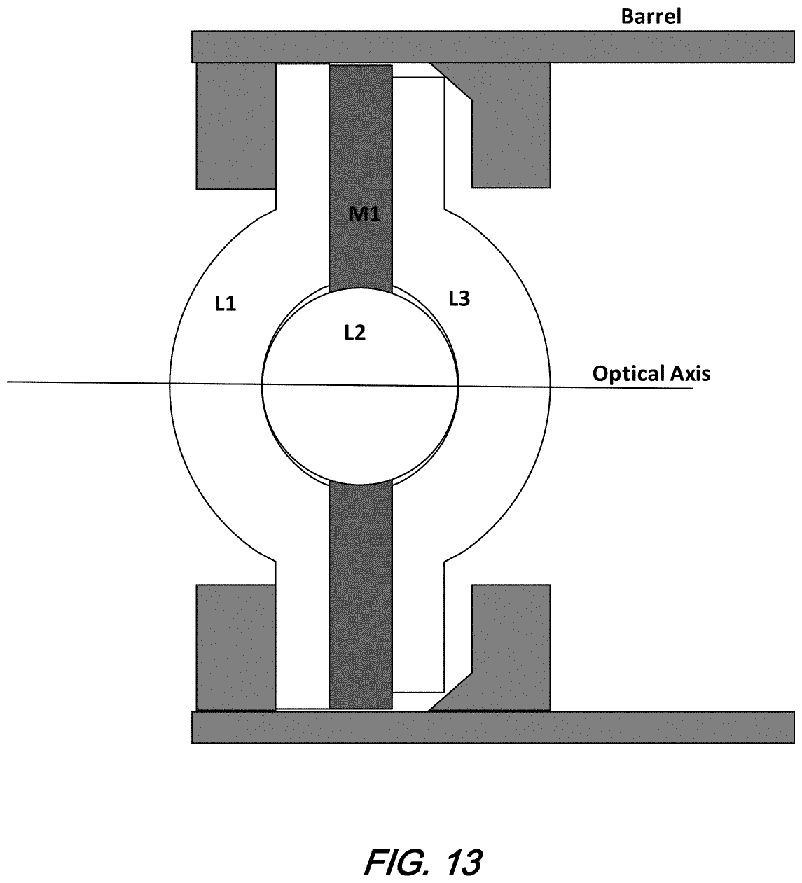

FIG. 13 illustrates an alternative lens design similar to that in FIG. 7, except that the masks M1, M2, and M2 are replaced with a single mask M1, which is compliant such a longitudinal loading force applied to the lens stack, for example by pressing a retaining ring on one side of the assembly towards a shoulder or retaining ring on the other side, compresses M1 until L1, L2, and L3 come into physical contact. Additional longitudinal force applied centers L1, L2, and L3 on the optical axis. Advantageously, a relatively large loading force can be applied to the assembly to ensure that the planar surfaces of the lens flanges in the barrel are pressed together achieving the correct tilt and spacing of the elements, with only a small portion of the total force applied to the glass ball L2 by meniscus lenses L1 and L3. For example, pressing the flange of L4 in FIG. 11 against the flange of L3 aids proper relative alignment of these two elements. The ball lens L2 contacts the meniscus lenses L1 and L3 at surfaces that are not planar and perpendicular to the longitudinal force, such as the center of the lenses near the optical axis or on the edges where the meniscus lens optical surface transitions to the flange (e.g. the various configurations of FIG. 5). An excessive loading force can deform the meniscus lenses, particularly if they are plastic, affecting the optical performance. A reduction in the air gap forming the TIR stop could result in a loss of TIR, for example. Also, excessive pressure on an optical surface could damage the surface and any coatings, such as an antireflection (AR) coating, thereupon.

The flexible mask M1 can serve multiple functions. First, it bears most of the longitudinal load, so that only a fraction is transmitted to the ball through contact with L1 and L3. Second, it presses against the flanges of L1 and L3, which helps prevent their deformation under the force applied to them by contact with the ball lens. Third, longitudinal compression of M1 results in its lateral spreading which causes M1 to press against and conform to the ball lens about its equator, thereby achieving an optical aperture on the surface of the ball lens L2.

M1 may be made from an elastomeric material such as rubber or foam. M1 is shown as a monolithic ring in FIG. 13, but it might also comprise multiple elements, some of which might be flexible and others rigid. The compliance could also be achieved by a spring mechanism such as a coil or cantilever spring.

A compliant element, such as an elastomeric ring, could also be placed elsewhere in the lens stack, for example between a lens flange and a mechanical stop such as a retaining ring. It would not reduce the load on L2 but would help to set a consistent longitudinal loading force on the overall assembly in manufacturing as the force is determined by the compression of this compliant element.

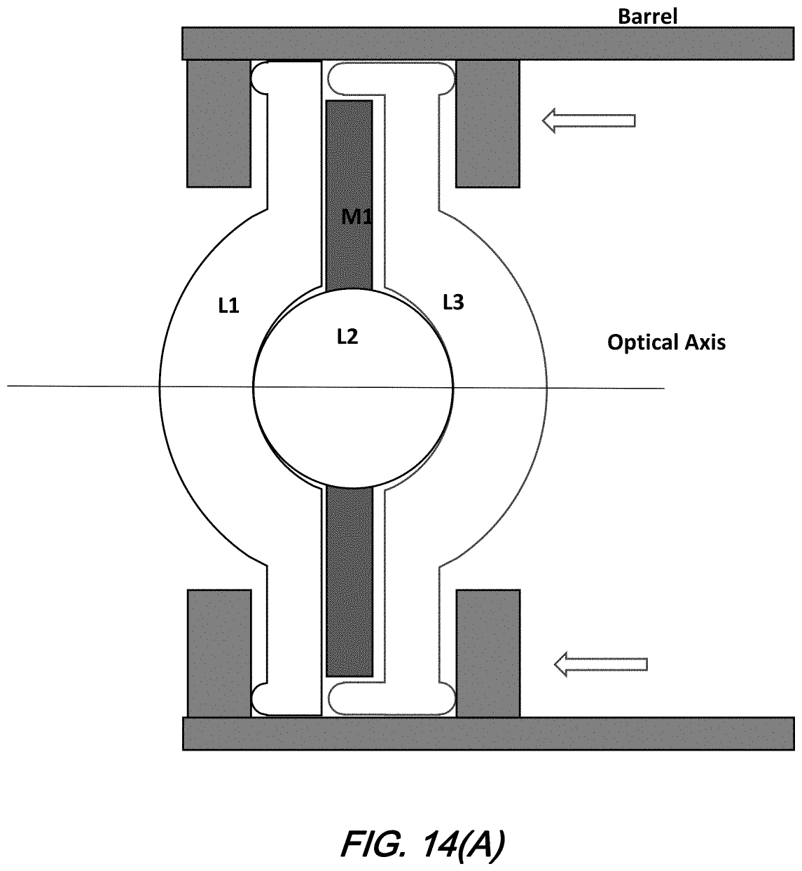

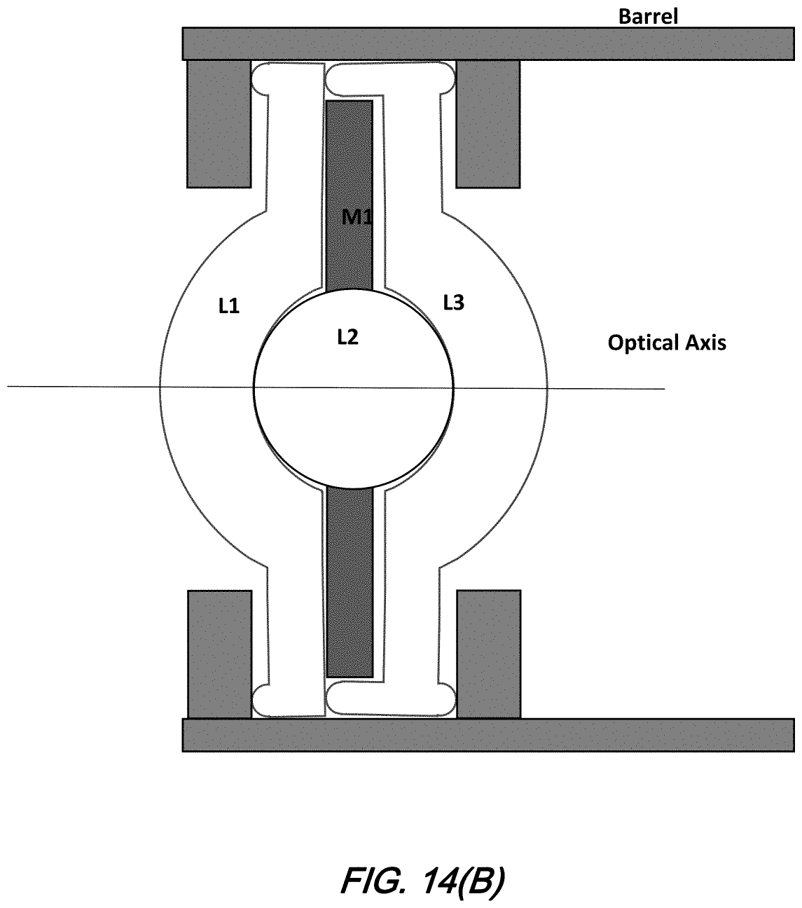

FIG. 14(A) and FIG. 14(B) illustrate alternative lens mounting arrangements according to aspects of the present disclosure. A force is applied to the lens stack to press meniscus lens L1 towards L3. This force may be transferred through retaining rings and mounting features of other lens elements in the stack (not shown). With a relatively low force applied, L1 and L3 contact interposed ball lens L2 and the three elements are forced to become laterally FIG. 14(B) concentric (they are centered on the optical axis), as is shown in FIG. 14(A).

FIG. 14(B) illustrates that with an increased force, the lenses elements L1 and L4 deform until the flanges of each lens make contact. Preferably the gap between the flanges shown in FIG. 14(A) is very small (e.g. 10 microns) so that the strain to achieve flange contact, as in FIG. 14(B), is small. Preferably, much or most of the L3 and L4 deformation occurs in the flanges so that the optical surfaces of L3 and L4 do not change substantially within their clear apertures and the air gap between L2 and L4 or L2 and L3, whichever forms the TIR stop, remains greater than one wavelength near the aperture edges. Once the configuration of FIG. 14(B) is achieved, increased force can be applied to the stack without further deformation of L1 and L3.

At this point, while we have presented this disclosure using some specific examples, those skilled in the art will recognize that our teachings are not so limited. Accordingly, this disclosure should be only limited by the scope of the claims attached hereto.

1. An optical apparatus comprising:
a lens assembly including a first medium, and a second medium, the first medium exhibiting a first index of refraction, the second medium exhibiting a second index of refraction;
wherein the first index of refraction is greater than the second index of refraction;
wherein total internal reflection of light at an interface between the first medium and the second medium forms an aperture stop on light transmission, said aperture stop having an edge defined by light ray angle of incidence on the interface;
the optical apparatus CHARACTERIZED IN THAT:
the interface between the first medium and the second medium exhibits a shape configured to produce the total internal reflection such that at least a portion of the light that undergoes the total internal reflection is reflected more than once at that interface.

2. The optical apparatus of claim 1 FURTHER CHARACTERIZED IN THAT: the light that undergoes total internal reflection does not reach an image surface of the apparatus.

3. The optical apparatus of claim 2 FURTHER CHARACTERIZED IN THAT: the light that undergoes total internal reflection either exits the apparatus through its front or is absorbed internally.

4. The optical apparatus of claim 1 FURTHER CHARACTERIZED IN THAT: the aperture stop interface surface is curved with a negative radius of curvature such that its center-of-curvature is in front of it (further from an image).

5. The optical apparatus of claim 1 FURTHER CHARACTERIZED IN THAT: light striking the aperture stop interface surface at an angle of incidence greater than a critical angle will, if it strikes that interface a second time, strike that interface at an angle greater than the critical angle.

6. The optical apparatus of claim 1 FURTHER CHARACTERIZED IN THAT: the second medium is at least one wavelength in thickness at an edge of the aperture stop.

7. The optical apparatus of claim 1 FURTHER CHARACTERIZED IN THAT: the first medium and the second medium are not monocentric.

8. The optical apparatus of claim 1 FURTHER CHARACTERIZED IN THAT: the aperture stop diameter does not vary substantially with field angle until vignetting occurs.

9. The optical apparatus of claim 1 FURTHER CHARACTERIZED IN THAT: the first medium comprises substantially a ball lens and the second medium exhibits substantially a meniscus shape.

10. An optical apparatus comprising:
a first meniscus lens;
a second meniscus lens; and
a ball lens interposed between and in physical contact with at least one of the first meniscus lens and the second meniscus lens such that an optical axis is defined by a path through the first meniscus lens, the ball lens, and the second meniscus lens;
wherein the ball lens and the second meniscus lens are configured to produce total internal reflection of particular light at one of: 1) an interface between the first meniscus lens and an air gap interposed between the first meniscus lens and the ball lens; and 2) an interface between the ball lens and an air gap interposed between the ball lens and the second meniscus lens; thereby forming an aperture stop on light transmission, said aperture stop having an edge defined by light ray angle of incidence on the interface.

11. The optical apparatus of claim 10 wherein the first meniscus lens exhibits a first refractive index, the ball lens exhibits a second refractive index, and the second meniscus lens exhibits a third refractive index.

12. The optical apparatus of claim 10 wherein the first meniscus lens has an interface surface exhibiting a radius of curvature R1, the ball lens has an interface surface exhibiting a radius of curvature R2, and the second meniscus lens has an interface surface exhibiting a radius of curvature R3, wherein R1≠R2, and R2≠R3

13. The optical apparatus of claim 12 wherein said apparatus is configured such that the R1 interface surface of the first meniscus lens contacts a portion of the R2 interface surface of the ball lens and the R3 interface surface of the second meniscus lens contacts a different portion of the R2 interface surface of the ball lens.

14. The optical apparatus of claim 10 further comprising an air gap following the ball lens along the optical axis, said air gap exhibiting a thickness less than 10 wavelengths of the particular light.

15. The optical apparatus of claim 10 further comprising an air gap preceding the ball lens along the optical axis, said air gap exhibiting a thickness less than 10 wavelengths of the particular light.

16. The optical apparatus of claim 10 wherein the ball lens contacts a concave surface curvature of the first meniscus lens such that they share an axis of rotational symmetry defined by the optical axis.

17. The optical apparatus of claim 10 wherein the ball lens contacts at least one of the first meniscus lens and the second meniscus lens substantially at the optical axis.

18. The optical apparatus of claim 10 wherein the ball lens contacts at least one of the first meniscus lens and the second meniscus lens outside of a clear aperture.

19. The optical apparatus of claim 10 wherein at least one meniscus lens includes one or more protrusions extending from a concave surface, said protrusions contacting and cradling the ball lens such that the at least one meniscus lens and the ball lens share an axis of rotational symmetry defined by an optical axis.

20. An optical apparatus for wide angle imaging CHARACTERIZED BY:
a substantially spherical volume of medium that provides spectral filtering of a focal spot, said filtering independent of field angle over a range of field angles, said focal spot moving with field angle, wherein said volume of medium is one selected from the group consisting of partially light absorptive medium and color glass.
